(19) United States
(12) Patent Application Publication
(10) Pub. No.: US 2025/0142367 A1
(43) Pub. Date: May 1, 2025

(54) DATA TRANSMISSION OPTIMIZATION METHOD AND APPARATUS, COMPUTER READABLE MEDIUM, AND ELECTRONIC DEVICE

(71) Applicant: TENCENT TECHNOLOGY (SHENZHEN) COMPANY LIMITED, Shenzhen (CN)

(72) Inventors: Yuhang JIA, Shenzhen (CN); Yixue Lei, Shenzhen (CN); Yunfei Zhang, Shenzhen (CN)

(73) Assignee: TENCENT TECHNOLOGY (SHENZHEN) COMPANY LIMITED, Shenzhen (CN)

(21) Appl. No.: 19/004,758

(22) Filed: Dec. 30, 2024

Related U.S. Application Data
(63) Continuation of application No. PCT/CN2023/106517, filed on Jul. 10, 2023.

(30) Foreign Application Priority Data
Nov. 25, 2022 (CN) 202211494681.2

(51) Int. Cl. H04W 24/02; H04W 48/16; H04W 80/12

(52) U.S. Cl. CPC H04W 24/02; H04W 48/16; H04W 80/12

(57) ABSTRACT

A data transmission optimization method, performed by a first application layer transmission optimization (ALTO) client, includes: obtaining, from a core network device, network transmission information of an access network exposed by an access network device to the core network device; obtaining ALTO information provided by an ALTO server; and performing data transmission optimization of the first ALTO client based on the ALTO information and the network transmission information of the access network.

### CROSS-REFERENCE TO RELATED APPLICATIONS

This application is a continuation application of International Application No. PCT/CN2023/106517 filed on Jul. 10, 2023, which claims priority to Chinese Patent Application No. 202211494681.2, filed with the China National Intellectual Property Administration on Nov. 25, 2022, the disclosures of each being incorporated by reference herein in their entireties.

### FIELD

The disclosure relates to the field of computer and communication technologies, and in particular, to a data transmission optimization method and apparatus, a computer-readable medium, and an electronic device.

### BACKGROUND

Application layer transmission optimization (ALTO) technologies may be configured for providing network topology information and network optimization services to suppliers to guide a user equipment (UE for short) to access nearby resources, which may reduce network traffic and may improve access quality. However, since existing ALTO solutions may fail to adequately consider relevant information of the network, network transmission efficiency may be affected.

### SUMMARY

Provided are a data transmission optimization method, performed by an application layer transmission optimization (ALTO) client, a data transmission optimization apparatus, a non-transitory computer-readable medium, and an electronic device.

According to some embodiments, a data transmission optimization method, performed by a first application layer transmission optimization (ALTO) client, includes: obtaining, from a core network device, network transmission information of an access network exposed by an access network device to the core network device; obtaining ALTO information provided by an ALTO server; and performing data transmission optimization of the first ALTO client based on the ALTO information and the network transmission information of the access network.

According to some embodiments, a data transmission optimization apparatus, includes: at least one memory configured to store computer program code; and at least one processor configured to read the program code and operate as instructed by the program code, the program code including: first obtaining code configured to cause at least one of the at least one processor to obtain, from a core network device, network transmission information of an access network exposed by an access network device to the core network device; second obtaining code configured to cause at least one of the at least one processor to obtain ALTO information provided by an ALTO server; and processing code configured to cause at least one of the at least one processor to perform data transmission optimization of a first ALTO client based on the ALTO information and the network transmission information of the access network.

According to some embodiments, a non-transitory computer-readable medium, storing computer code which, when executed by at least one processor, causes the at least one processor to at least: obtain, from a core network device, network transmission information of an access network exposed by an access network device to the core network device; obtain ALTO information provided by an ALTO server; and perform data transmission optimization of a first ALTO client based on the ALTO information and the network transmission information of the access network.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram showing a system architecture for implementing application layer transmission optimization (ALTO) optimization based on a 5G network.

FIG. 2 is a flowchart of a data transmission optimization method according to some embodiments.

FIG. 3 is a flowchart of a data transmission optimization method according to some embodiments.

FIG. 4 is a flowchart of a data transmission optimization method according to some embodiments.

FIG. 5 is a flowchart of a data transmission optimization method according to some embodiments.

FIG. 6 is a flowchart of a data transmission optimization method according to some embodiments.

FIG. 7 is a flowchart of a data transmission optimization method according to some embodiments.

FIG. 8 is a block diagram of a data transmission optimization apparatus according to some embodiments.

FIG. 9 is a block diagram of a data transmission optimization apparatus according to some embodiments.

FIG. 10 is a schematic structural diagram of a computer system adapted to implement an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The block diagrams shown in the accompanying drawings describe exemplary functional entities and do not necessarily correspond to physically independent entities. The entities may be implemented in a software form, or in one or more hardware modules or integrated circuits, or in different networks and/or processor apparatuses and/or microcontroller apparatuses.

The flowcharts shown in the accompanying drawings are exemplary descriptions, and operations may be executed in orders other than the described orders. Additionally, some operations may be further divided, and some operations may be merged or partially merged.

“A plurality of” mentioned herein means two or more. The term “and/or” is used for describing an association relationship between associated objects and representing that three relationships may exist. For example, A and/or B may represent the following three cases: only A exists, both A and B exist, and only B exists. The character “/” may indicate an “or” relationship between a preceding associated object and a latter associated object.

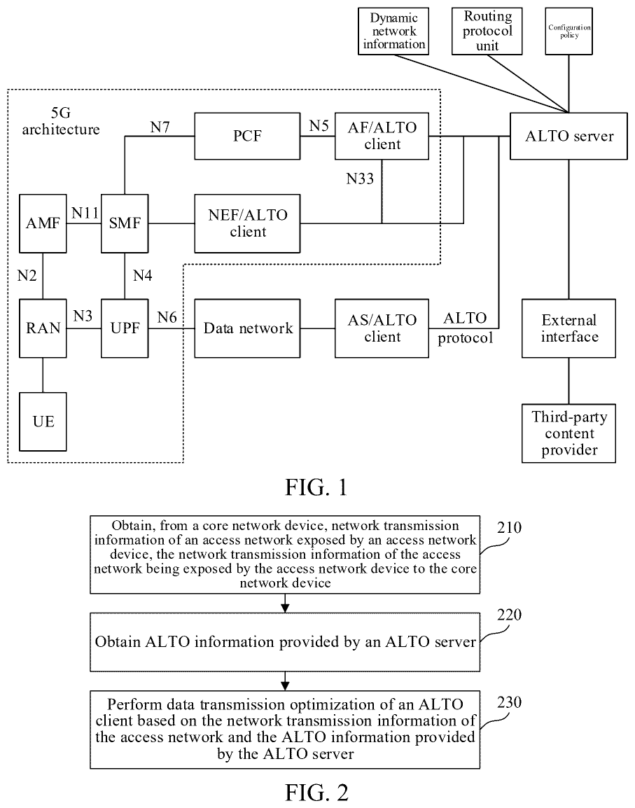

FIG. 1 is a schematic diagram of a system architecture for implementing application layer transmission optimization (ALTO) optimization based on a 5G network. AF stands for application function, which may also serve as an application server (AS). The AF may implement a control plane function of a third-party AS, and perform interaction through an AF-network exposure function (NEF)-policy control function (PCF) or AF-PCF. The AS may implement a user plane function (UPF) of the third-party AS, for example, an AS-IP transmission network-UPF interface.

SMF stands for session management function, which is responsible for tunnel maintenance, IP address assignment and management, UPF selection, policy implementation and quality of service (QOS) control, charging data collection, service roaming, and the like.

AMF stands for access and mobility management function, which may be configured to perform registration, connection, accessibility, and mobility management, and is also configured to provide a session management message transmission channel for a user equipment (UE) and the SMF, and provide identification and authentication functions for UE access. The AMF is a core network control plane access point of the UE and a radio access network (RAN).

PCF stands for policy control function, which may be configured to manage a unified policy framework and provide policy rules for control plane functions.

UPF stands for user plane function, which is responsible for packet routing and forwarding, policy implementation, traffic reporting, QoS handling, and the like. A UPF entity is an entity that implements a UPF.

The NEF is located between a 5G core network and external third-party application functionaries (and may be between some internal AFs), and is responsible for managing the external network exposure data, and all external applications that want to access the internal data of the 5G core network may pass through the NEF. The NEF provides corresponding security guarantees to ensure the security of external applications to a network side, and the NEF also provides functions such as QoS customization exposure ability of external applications, mobility state event subscription, and AF request distribution. A NEF entity is an entity that implements the NEF.

DN stands for data network. In a 5G system, one of key tasks of the network is providing a connection to the DN for a terminal. The DN may be Internet, an IP multimedia subsystem (IMS), or the like.

The UE is a user terminal, which may include one or more of a smartphone, a tablet computer, a notebook computer, a desktop computer, a smart speaker, a smartwatch, an on-board terminal, a smart television, and the like.

An ALTO server is a server of an ALTO architecture. The ALTO is an ALTO protocol based on the IP layer, which is responsible for providing a network location structure and network path preference, with the goal of modifying the network resource consumption pattern while maintaining or improving application performance. Correspondingly, the ALTO client is a client of the ALTO architecture.

A third-party content provider is responsible for providing services for applications, for example, a video content provider and a news content provider.

Dynamic network information is IP-based dynamic network information in the ALTO architecture.

A routing protocol unit includes routing protocols. A routing protocol unit in the ALTO architecture is an IP-based routing protocol unit.

A configuration policy, for example, a provisioning policy, is an ALTO-based network configuration information policy in the ALTO architecture.

Based on the system architecture shown in FIG. 1 in some embodiments, the ALTO client may obtain network transmission information of an access network exposed by an access network device, and obtain ALTO information provided by an ALTO server, to perform data transmission optimization of the ALTO client based on the ALTO information and the network transmission information of the access network. Information may be integrated to implement data transmission optimization, so as to select a relatively appropriate end-to-end transmission path, and then data transmission efficiency of a network may be improved.

Implementation details of the technical solutions of some embodiments are described in detail below.

FIG. 2 is a flowchart of a data transmission optimization method according to some embodiments. The data transmission optimization method may be performed by an ALTO client. Referring to FIG. 2, the data transmission optimization method includes at least operation 210 to operation 230. The detailed description is as follows.

In operation 210, network transmission information of an access network exposed by an access network device is obtained from a core network device, the network transmission information of the access network being exposed by the access network device to the core network device.

In some embodiments, a process of obtaining, from the core network device, the network transmission information of the access network exposed by the access network device may be obtaining, from an AF entity, the network transmission information of the access network exposed by the access network device. In this case, the access network device (such as a base station) may transmit the network transmission information of the access network to the AF entity through a protocol data unit (PDU) session established between the access network device and the AF entity.

The access network device may transmit the network transmission information of the access network to the AMF. Then the network transmission information of the access network is forwarded by the AMF to the SMF, then forwarded by the SMF to the PCF, then forwarded by the PCF to the NEF, and forwarded by the NEF to the AF entity.

In some embodiments, the network transmission information of the access network includes at least one of the following: wireless link state information, a throughput, transmission delay information, and delay jitter information of an access network.

The wireless link state may be measured through parameters such as a signal to interference plus noise ratio (SINR), a reference signal receiving power (RSRP), reference signal receiving quality (RSRQ), and a received signal strength indication (RSSI). The transmission delay information may be information such as a transmission delay of a data packet. The delay jitter information may be change information of the transmission delay, or the like.

In operation 220, ALTO information provided by an ALTO server is obtained.

In some embodiments, the ALTO client may obtain, from a core network device, the ALTO information provided by the ALTO server. In this case, the ALTO information is obtained by another ALTO client from the ALTO server and transmitted to the core network device. For example, the ALTO client close to a UPF may identify the ALTO server through an ALTO service discovery process. After the ALTO server is identified, an ALTO information obtaining request may be transmitted to the ALTO server, to obtain the ALTO information from the ALTO server. After the ALTO information is obtained, the ALTO client may transmit the obtained ALTO information to the core network device through a DN via an external interface.

In some embodiments, a process of obtaining, from the core network device by the ALTO client, the ALTO information provided by the ALTO server may be obtaining the ALTO information from a NEF. In this case, another ALTO client obtains the ALTO information from the ALTO server and then transmits the ALTO information to the NEF through the DN.

In some embodiments, a process of obtaining, from the core network device by the ALTO client, the ALTO information provided by the ALTO server may be obtaining the ALTO information from the AF. In this case, another ALTO client obtains the ALTO information from the ALTO server and then transmits the ALTO information to the NEF through the DN, and then the ALTO information is transmitted by the NEF to the AF.

In some embodiments, the process of obtaining, by the ALTO client, the ALTO information provided by the ALTO server may be performing the ALTO service discovery process, then transmitting the ALTO information obtaining request to the ALTO server after identifying the ALTO server, and then receiving the ALTO information fed back by the ALTO server.

In some embodiments, when the ALTO client receives the ALTO information fed back by the ALTO server, the ALTO information may further be transmitted to the core network device through the DN, so that the core network device exposes the ALTO information to the another ALTO client. For example, the ALTO client may transmit the ALTO information to the UPF entity through the DN, and then the ALTO information is provided by the UPF to the another ALTO client through the NEF entity. In some embodiments, the NEF may directly expose the ALTO information to the another ALTO client, or may transmit the ALTO information to the AF, and then the ALTO information is exposed by the AF to the another ALTO client.

In some embodiments, the ALTO information may include at least one of the following: IP-based dynamic network information, IP-based routing protocol unit information, and ALTO-based network configuration policy information.

In operation 230, data transmission optimization of the ALTO client is performed based on the network transmission information of the access network and the ALTO information provided by the ALTO server.

In some embodiments, since the ALTO client obtains the network transmission information of the access network and the ALTO information provided by the ALTO server, information may be integrated to implement data transmission optimization. In some embodiments, the data transmission optimization process of the ALTO client may be data transmission optimization at an application layer, or may be optimization at a transport layer. For example, a division mode of data packets at the application layer and a data packet size may be adjusted by selecting a relatively appropriate end-to-end transmission path, to improve data transmission efficiency of a network.

Some embodiments as illustrated in FIG. 2, for example, are described from a perspective of the ALTO client. Some embodiments are also described from the perspective of the ALTO server with reference to FIG. 3.

FIG. 3 is a flowchart of a data transmission optimization method according to some embodiments. The data transmission optimization method may be performed by an ALTO server. Referring to FIG. 3, the data transmission optimization method includes at least operation 310 to operation 320. The detailed description is as follows.

In operation 310, an ALTO information obtaining request transmitted by an ALTO client is received.

In some embodiments, the ALTO client may perform an ALTO service discovery process, then transmit the ALTO information obtaining request to the ALTO server after identifying the ALTO server, and then feed back ALTO information to the ALTO client after the ALTO server receives the ALTO information obtaining request.

In operation 320, the ALTO information is exposed to the ALTO client based on the ALTO information obtaining request, so that the ALTO client performs data transmission optimization of the ALTO client based on the ALTO information and network transmission information of an access network exposed by an access network device,
the network transmission information of the access network being exposed by the access network device to a core network device, and provided by the core network device to the ALTO client.

In some embodiments, for the process of obtaining, by the ALTO client, the network transmission information of the access network exposed by the access network device and the process of performing the data transmission optimization of the ALTO client based on the ALTO information and the network transmission information of the access network exposed by the access network device, reference may be made to the technical solutions of the foregoing descriptions.

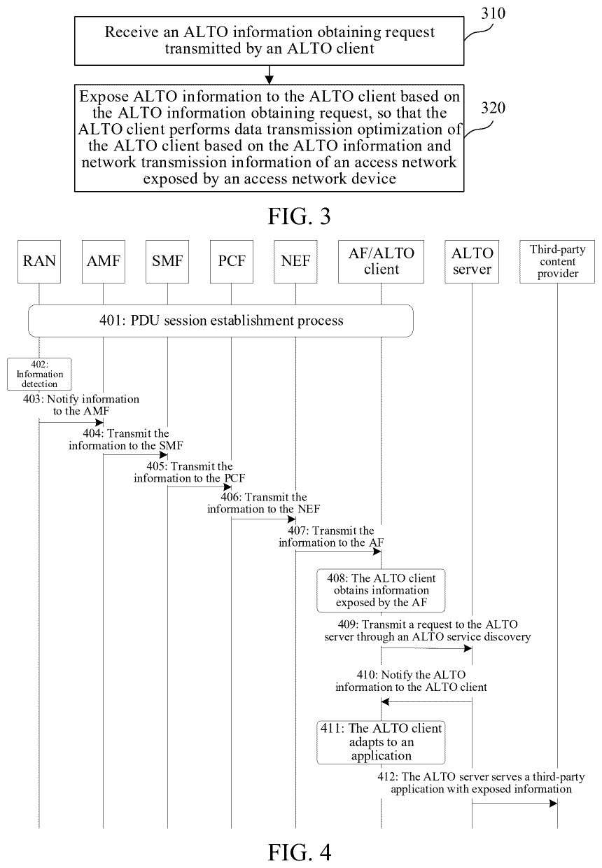

A process in which a plurality of entities interact are described below with reference to FIG. 4 to FIG. 7.

As shown in FIG. 4, a data transmission optimization method according to some embodiments includes the following operations.
401: Perform a PDU session establishment process between a RAN and an AF entity.

In some embodiments, an ALTO client and the AF may be respectively used as a network element, or may be merged into a network element.
402: The RAN performs an information detection process.

In some embodiments, a RAN side may detect and collect information at a frequency. The information may include information of a base station side and transmission information for each UE, for example, may include network state information, a throughput, delay, and jitter. The network state information includes an SINR, an RSSI, an RSRP, an RSRQ, and the like. Based on service requirements, the information may be used as mandatory information or alternative information.
403: The RAN notifies detected RAN-side related information to an AMF.
404: The AMF transmits the RAN-side related information to an SMF.

In some embodiments, with reference to FIG. 1, the AMF may transmit an Nsmf_PDUSession_UpdateSM message to the SMF through an interface N11. The message is converted from the information transmitted from the RAN side received by the AMF, and the message includes the RAN-side related information.
405: The SMF transmits the RAN-side related information to a PCF.

In some embodiments, with reference to FIG. 1, the SMF may transmit an Npcf_SMPolicyControl_Update message to the PCF through an interface N7. The message is converted from the information transmitted from the AMF side received by the SMF, and the message includes the RAN-side related information.
406: The PCF transmits the RAN-side related information to a NEF.

In some embodiments, the PCF may transmit an Npcf_PolicyAuthorization_Notify message to the NEF through an interface N5. The message is converted from the information transmitted from the SMF side received by the PCF, and the message includes the RAN-side related information.
407: The NEF transmits the RAN-side related information to the AF.

In some embodiments, the NEF may transmit an Nnef_EventExposure message to the AF through an interface N33. The message is converted from the information transmitted from the PCF side received by the NEF, and the message includes the RAN-side related information.
408: The ALTO client obtains information exposed by the AF.

In some embodiments, since the RAN-side related information has been transmitted from the NEF to the AF, the ALTO client may obtain the RAN-side related information from the information exposed by the AF.
409: The ALTO client transmits a request to the ALTO server through an ALTO service discovery.

In some embodiments, the ALTO client may perform an ALTO service discovery service, transmit a request to the ALTO server, and identify the ALTO server. In addition, the ALTO client may also expose the RAN-side related information to the ALTO server, so that the ALTO server provides an internet service to a third-party application through an external interface.
410: The ALTO server notifies the ALTO information to the ALTO client.

In some embodiments, the ALTO server may feed back the ALTO information of the ALTO server to the ALTO client after receiving the request transmitted by the ALTO client.
411: The ALTO client integrates the RAN-side related information and the ALTO information to adapt to an application.

In some embodiments, the ALTO client may aggregate and analyze the RAN-side related information and the ALTO information after obtaining the two types of information, to implement data transmission optimization. For example, the data transmission optimization may be data transmission optimization at an application layer, or may be optimization at a transport layer. A division mode of data packets at the application layer and a data packet size may be adjusted by selecting a relatively appropriate end-to-end transmission path, to improve data transmission efficiency of a network.
412: The ALTO server uses exposed information to serve the third-party application.

In some embodiments, the ALTO server may expose the ALTO information to a third-party application provider, for example, a video content provider and a news content provider, so that the third-party application provider performs the data transmission optimization based on the ALTO information.

In some embodiments as illustrated in FIG. 4, for example, the RAN-side related information is exposed from a control plane (such as the NEF and the AF), and then an end-to-end data transmission path is selected by the ALTO client based on the ALTO information provided by the ALTO server to perform the data transmission optimization.

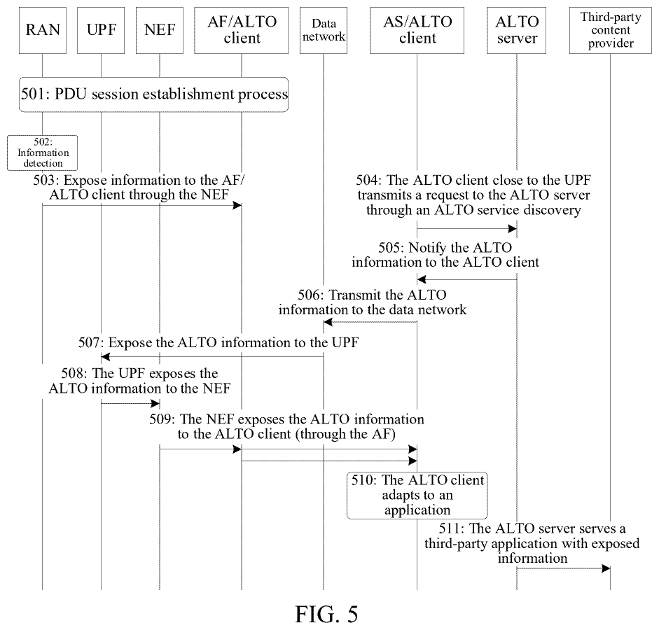

As shown in FIG. 5, a data transmission optimization method according to some embodiments includes the following operations.
501: Perform a PDU session establishment process between a RAN and an AF.

In some embodiments, an ALTO client and the AF may be respectively used as a network element, or may be merged into a network element.
502: The RAN performs an information detection process.

In some embodiments, a RAN side may detect and collect information at a frequency. The information may include information of a base station side and transmission information for each UE, for example, may include network state information, a throughput, delay, and jitter. The network state information includes an SINR, an RSSI, an RSRP, an RSRQ, and the like. Based on service requirements, the information may be used as mandatory information or alternative information.
503: The RAN exposes the information to the AF/ALTO client through a NEF.

In some embodiments, the RAN may notify detected RAN-side related information to the AMF. The AMF transmits the RAN-side related information to the SMF, the SMF transmits the RAN-side related information to a PCF, the PCF transmits the RAN-side related information to the NEF, and then the NEF transmits the RAN-side related information to the AF. The ALTO client may obtain the RAN-side related information from the AF.

In some embodiments, the AMF may transmit an Nsmf_PDUSession_UpdateSM message to the SMF through an interface N11. The message is converted from the information transmitted from the RAN side received by the AMF. The SMF may transmit an Npcf_SMPolicyControl_Update message to the PCF through an interface N7. The message is converted from the information transmitted from the AMF side received by the SMF. The PCF may transmit an Npcf_PolicyAuthorization_Notify message to the NEF through an interface N5. The message is converted from the information transmitted from the SMF side received by the PCF. The NEF may transmit an Nnef_EventExposure message to the AF through an interface N33. The message is converted from the information transmitted from the PCF side received by the NEF.
504: The ALTO client close to a UPF transmits a request to the ALTO server through an ALTO service discovery.

In some embodiments, the ALTO client close to the UPF may perform an ALTO service discovery service, transmit a request to the ALTO server, and identify the ALTO server. In addition, the ALTO client may also expose the RAN-side related information to the ALTO server, so that the ALTO server provides an internet service to a third-party application through an external interface.
505: The ALTO server notifies the ALTO information to the ALTO client.

In some embodiments, the ALTO server may feed back the ALTO information of the ALTO server to the ALTO client after receiving the request transmitted by the ALTO client.
506: The ALTO client transmits the ALTO information to a DN.

In some embodiments, the ALTO client may transmit the ALTO information to the DN (for example, the Internet) through an external interface. In some embodiments, the ALTO client may transmit the RAN-side related information to the DN and perform the following similar operations 507-509 on the ALTO information.
507: The DN exposes the ALTO information to the UPF.

In some embodiments, the DN may expose the ALTO information to the UPF through an interface N6.
508: The UPF exposes the ALTO information to the NEF.

In some embodiments, the UPF may expose the ALTO information to the SMF through an interface N4, then the SMF transmits the ALTO information to the PCF, and the PCF transmits the ALTO information to the NEF.
509: The NEF exposes the ALTO information to the ALTO client (through the AF).

In some embodiments, the NEF may expose the ALTO information to the ALTO client in two manners. A first manner is directly exposing the ALTO information to the ALTO client by the NEF, and the other manner is transmitting Nnef_EventExposure information to the AF by the NEF, and then exposing the ALTO information to the ALTO client by the AF.
510: The ALTO client integrates the RAN-side related information and the ALTO information to adapt to an application.

In some embodiments, the ALTO client may aggregate and analyze the RAN-side related information and the ALTO information after obtaining the two types of information, to implement data transmission optimization. For example, the data transmission optimization may be data transmission optimization at an application layer, or may be optimization at a transport layer. A division mode of data packets at the application layer and a data packet size may be adjusted by selecting a relatively appropriate end-to-end transmission path, to improve data transmission efficiency of a network.
511: The ALTO server uses exposed information to serve the third-party application.

In some embodiments, the ALTO server may expose the ALTO information to a third-party application provider, for example, a video content provider and a news content provider, so that the third-party application provider performs the data transmission optimization based on the ALTO information.

In some embodiments as illustrated in FIG. 5, for example, a plurality of ALTO clients may respectively expose network information (for example, the RAN-side related information) from a control plane (the AF, the NEF, or the like) and a user plane (the UPF, the DN, or the like), and then an end-to-end data transmission path is selected by the ALTO client based on the ALTO information provided by the ALTO server to perform the data transmission optimization. Network exposure information may be selected on the user plane and the control plane (the same information is transmitted only from the user plane or only from the control plane), and backed up and supplemented (the same information is available on both the control plane and the user plane, and backed up and supplemented each other).

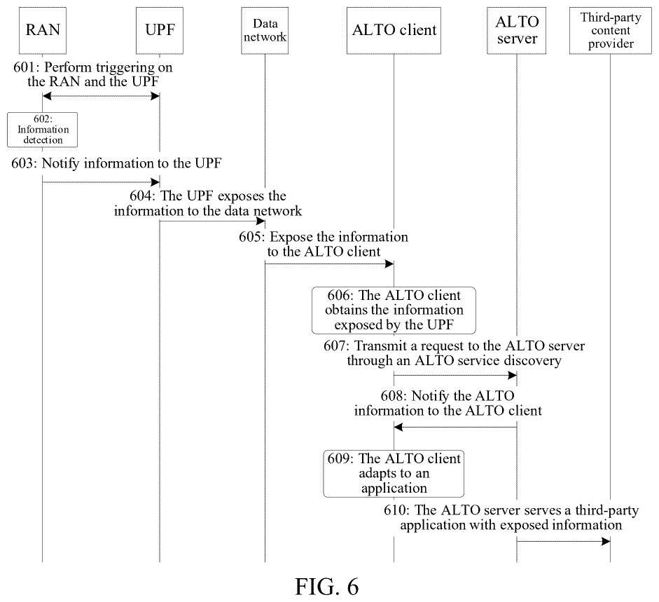

As shown in FIG. 6, a data transmission optimization method according to some embodiments includes the following operations.
601: Perform triggering on a RAN and a UPF.

A RAN side and the UPF respectively trigger a response, and perform a network information exposure service through a user plane.
602: The RAN performs an information detection process.

In some embodiments, a RAN side may detect and collect information at a frequency. The information may include information of a base station side and transmission information for each UE, for example, may include network state information, a throughput, delay, and jitter. The network state information includes an SINR, an RSSI, an RSRP, an RSRQ, and the like. Based on service requirements, the information may be used as mandatory information or alternative information.
603: The RAN notifies the information to the UPF.

In some embodiments, the RAN may notify detected RAN-side related information to the UPF through an interface N3.
604: The UPF exposes the information to a DN.

In some embodiments, the UPF may expose the RAN-side related information to the DN through an interface N6.
605: The DN exposes the information to an ALTO client.

In some embodiments, the DN may expose the RAN-side related information to the ALTO client through an external interface.
606: The ALTO client obtains the information exposed by the UPF.

In some embodiments, the RAN-side related information has been exposed to the DN by the UPF. Therefore, the ALTO client may obtain the RAN-side related information.
607: The ALTO client transmits a request to the ALTO server through an ALTO service discovery.

In some embodiments, the ALTO client may perform an ALTO service discovery service, transmit a request to the ALTO server, and identify the ALTO server. In addition, the ALTO client may also expose the RAN-side related information to the ALTO server, so that the ALTO server provides an internet service to a third-party application through an external interface.
608: The ALTO server notifies the ALTO information to the ALTO client.

In some embodiments, the ALTO server may feed back the ALTO information of the ALTO server to the ALTO client after receiving the request transmitted by the ALTO client.
609: The ALTO client integrates the RAN-side related information and the ALTO information to adapt to an application.

In some embodiments, the ALTO client may aggregate and analyze the RAN-side related information and the ALTO information after obtaining the two types of information, to implement data transmission optimization. For example, the data transmission optimization may be data transmission optimization at an application layer, or may be optimization at a transport layer. A division mode of data packets at the application layer and a data packet size may be adjusted by selecting a relatively appropriate end-to-end transmission path, to improve data transmission efficiency of a network.
610: The ALTO server uses exposed information to serve the third-party application.

In some embodiments, the ALTO server may expose the ALTO information to a third-party application provider, for example, a video content provider and a news content provider, so that the third-party application provider performs the data transmission optimization based on the ALTO information.

In some embodiments as illustrated in FIG. 6, for example, the RAN-side related information is exposed from the user plane (for example, the UPF and the DN), and then an end-to-end data transmission path is selected by the ALTO client based on the ALTO information provided by the ALTO server to perform the data transmission optimization.

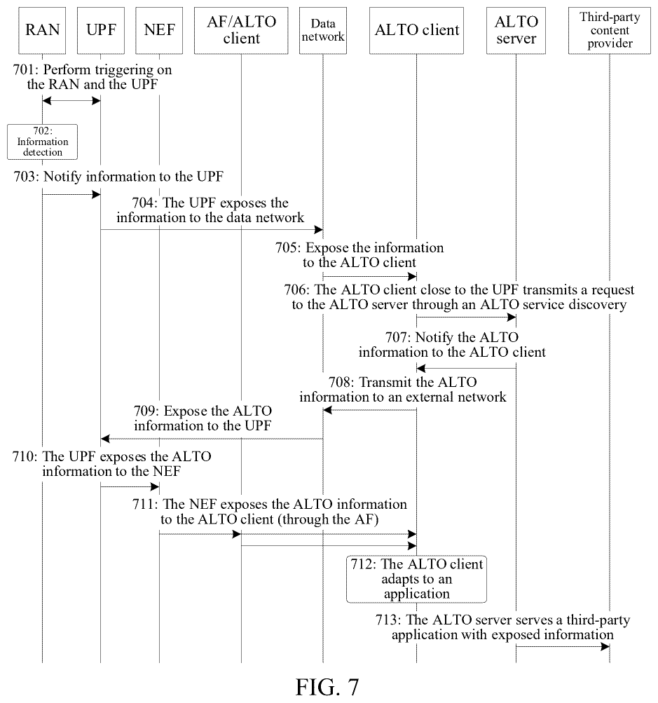

As shown in FIG. 7, a data transmission optimization method according to some embodiments includes the following operations.
701: Perform triggering by a RAN and a UPF.

A RAN side and the UPF respectively trigger a response, and perform a network information exposure service through a user plane.
702: The RAN performs an information detection process.

In some embodiments, a RAN side may detect and collect information at a frequency. The information may include information of a base station side and transmission information for each UE, for example, may include network state information, a throughput, delay, and jitter. The network state information includes an SINR, an RSSI, an RSRP, an RSRQ, and the like. Based on service requirements, the information may be used as mandatory information or alternative information.
703: The RAN notifies the information to the UPF.

In some embodiments, the RAN may notify detected RAN-side related information to the UPF through an interface N3.
704: The UPF exposes the information to a DN.

In some embodiments, the UPF may expose the RAN-side related information to the DN through an interface N6.
705: The DN exposes the information to an ALTO client.

In some embodiments, the DN may expose the RAN-side related information to the ALTO client through an external interface. The RAN-side related information has been exposed to the DN by the UPF. Therefore, the ALTO client may obtain the RAN-side related information.
706: The ALTO client close to a UPF transmits a request to the ALTO server through an ALTO service discovery.

In some embodiments, the ALTO client close to the UPF may perform an ALTO service discovery service, transmit a request to the ALTO server, and identify the ALTO server. In addition, the ALTO client may also expose the RAN-side related information to the ALTO server, so that the ALTO server provides an internet service to a third-party application through an external interface.
707: The ALTO server notifies the ALTO information to the ALTO client.

In some embodiments, the ALTO server may feed back the ALTO information of the ALTO server to the ALTO client after receiving the request transmitted by the ALTO client.
708: The ALTO client transmits the ALTO information to the DN.

In some embodiments, the ALTO client may transmit the ALTO information to the DN (for example, the Internet) through an external interface. In some embodiments, the ALTO client may further transmit the RAN-side related information to the DN and perform the following similar operations 709-711 on the ALTO information.
709: The DN exposes the ALTO information to the UPF.

In some embodiments, the DN may expose the ALTO information to the UPF through an interface N6.
710: The UPF exposes the ALTO information to the NEF.

In some embodiments, the UPF may expose the ALTO information to the SMF through an interface N4, then the SMF transmits the ALTO information to the PCF, and the PCF transmits the ALTO information to the NEF.
711: The NEF exposes the ALTO information to the ALTO client (through the AF).

In some embodiments, the NEF may expose the ALTO information to the ALTO client in two manners. A first manner is directly exposing the ALTO information to the ALTO client by the NEF, and the other manner is transmitting Nnef_EventExposure information to the AF by the NEF, and then exposing the ALTO information to the ALTO client by the AF.
712: The ALTO client integrates the RAN-side related information and the ALTO information to adapt to an application.

In some embodiments, the ALTO client may aggregate and analyze the RAN-side related information and the ALTO information after obtaining the two types of information, to implement data transmission optimization. For example, the data transmission optimization may be data transmission optimization at an application layer, or may be optimization at a transport layer. A division mode of data packets at the application layer and a data packet size may be adjusted by selecting a relatively appropriate end-to-end transmission path, to improve data transmission efficiency of a network.
713: The ALTO server uses exposed information to serve the third-party application.

In some embodiments, the ALTO server may expose the ALTO information to a third-party application provider, for example, a video content provider and a news content provider, so that the third-party application provider performs the data transmission optimization based on the ALTO information.

In some embodiments as illustrated in FIG. 7, for example, a plurality of ALTO clients may expose network information (for example, the RAN-side related information) from the user plane (the UPF, the DN, or the like), and then an end-to-end data transmission path is selected by the ALTO client based on the ALTO information provided by the ALTO server to perform the data transmission optimization.

In some embodiments, the ALTO client can consider the ALTO information provided by the ALTO server and the network transmission information of the access network (for example, the RAN-side related information) exposed by the access network device when the data transmission optimization is performed. Information may be integrated to implement data transmission optimization, so as to select the relatively appropriate end-to-end transmission path, thereby improving the data transmission efficiency of the network.

An apparatus according to some embodiments is described below, which may be configured for performing the data transmission optimization method in the foregoing descriptions. Accordingly, reference may be made to the foregoing descriptions of the data transmission optimization method.

FIG. 8 is a block diagram of a data transmission optimization apparatus according to some embodiments. The data transmission optimization apparatus may be arranged in an ALTO client.

With reference to FIG. 8, a data transmission optimization apparatus 800 according to some embodiments includes an obtaining unit 802 and a processing unit 804.

The obtaining unit 802 is configured to: obtain, from a core network device, network transmission information of an access network exposed by an access network device, the network transmission information of the access network being exposed by the access network device to the core network device; and obtain ALTO information provided by an ALTO server. The processing unit 804 is configured to perform data transmission optimization of an ALTO client based on the ALTO information and the network transmission information of the access network.

In some embodiments, based on the foregoing solutions, the obtaining unit 802 is configured to obtain the ALTO information from the core network device, the ALTO information being obtained from the ALTO server by another ALTO client and transmitted to the core network device.

In some embodiments, based on the foregoing solutions, the obtaining unit 802 is configured to obtain the ALTO information from a NEF entity, the ALTO information being transmitted to the NEF entity by the another ALTO client through a DN.

In some embodiments, based on the foregoing solutions, the obtaining unit 802 is configured to obtain the ALTO information from an AF entity, the ALTO information being transmitted to a NEF entity by the another ALTO client through the DN, and transmitted to the AF entity by the NEF entity.

In some embodiments, based on the foregoing solutions, the obtaining unit 802 is configured to: perform an ALTO service discovery process, and transmit an ALTO information obtaining request to the ALTO server after identifying the ALTO server; and
receive the ALTO information fed back by the ALTO server.

In some embodiments, based on the foregoing solutions, the data transmission optimization apparatus 800 further includes a transmitting unit, configured to transmit the ALTO information to the core network device through the DN after receiving the ALTO information fed back by the ALTO server, so that the core network device exposes the ALTO information to another ALTO client.

In some embodiments, based on the foregoing solutions, the transmitting unit is configured to transmit the ALTO information to a UPF entity through the DN, so that the UPF entity provides the ALTO information to the another ALTO client through the NEF entity.

In some embodiments, based on the foregoing solutions, the obtaining unit 802 is configured to obtain, from the AF entity, the network transmission information of the access network exposed by the access network device, the network transmission information of the access network being transmitted to the AF entity by the access network device through a PDU session established between the access network device and the AF entity.

In some embodiments, based on the foregoing solutions, the network transmission information of the access network includes at least one of the following: wireless link state information, a throughput, transmission delay information, and delay jitter information of an access network.

In some embodiments, based on the foregoing solutions, the ALTO information includes at least one of the following: IP-based dynamic network information, IP-based routing protocol unit information, and ALTO-based network configuration policy information.

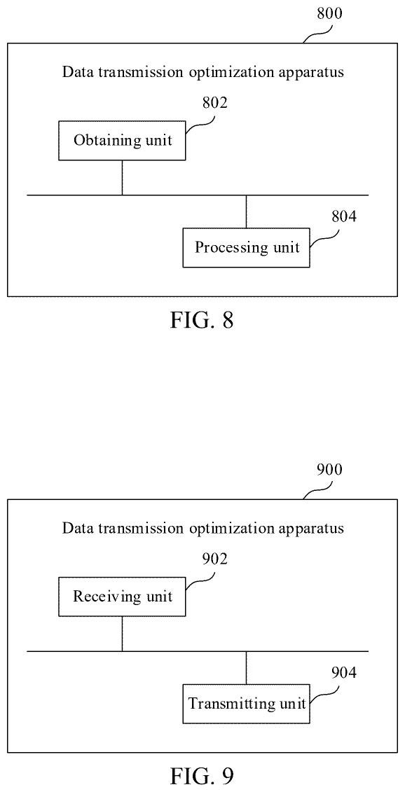

FIG. 9 is a block diagram of a data transmission optimization apparatus according to some embodiments. The data transmission optimization apparatus may be arranged in an ALTO server.

With reference to FIG. 9, a data transmission optimization apparatus 900 according to some embodiments includes a receiving unit 902 and a transmitting unit 904.

The receiving unit 902 is configured to receive an ALTO information obtaining request transmitted by an ALTO client. The transmitting unit 904 is configured to expose the ALTO information to the ALTO client based on the ALTO information obtaining request, so that the ALTO client performs data transmission optimization of the ALTO client based on the ALTO information and network transmission information of an access network exposed by an access network device, the network transmission information of the access network being exposed by the access network device to a core network device, and provided by the core network device to the ALTO client.

According to some embodiments, each entity or unit may exist respectively or be combined into one or more units. Some entities or units may be further split into multiple smaller function subunits, thereby implementing the same operations without affecting the technical effects of some embodiments. The entities or units are divided based on logical functions. In actual applications, a function of one entity or unit may be realized by multiple entities or units, or functions of multiple entities or units may be realized by one entity or unit. In some embodiments, additional entities or units may be included. In actual applications, these functions may also be realized cooperatively by the other entities or units, and may be realized cooperatively by multiple entities or units.

A person skilled in the art would understand that these “entities” or “units” could be implemented by hardware logic, a processor or processors executing computer software code, or a combination of both. The “entities” or “units” may also be implemented in software stored in a memory of a computer or a non-transitory computer-readable medium, where the instructions of each unit are executable by a processor to thereby cause the processor to perform the respective operations of the corresponding entity or unit.

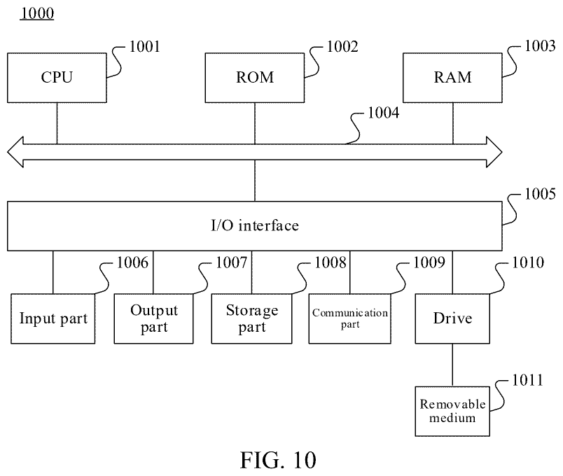

FIG. 10 is a schematic structural diagram of a computer system adapted to implement an electronic device according to some embodiments.

A computer system 1000 of the electronic device shown in FIG. 10 is an example, and does not constitute any limitation on functions and a range of application of some embodiments.

As shown in FIG. 10, the computer system 1000 includes a central processing unit (CPU) 1001, which may perform various actions and processes based on a program stored in a read-only memory (ROM) 1002 or a program loaded from a storage part 1008 into a random access memory (RAM) 1003, for example, perform the method according to some embodiments. The RAM 1003 further has various programs and data required for system operation stored therein. The CPU 1001, the ROM 1002, and the RAM 1003 are connected to each other through a bus 1004. An input/output (I/O) interface 1005 is also connected to the bus 1004.

The following components are connected to the I/O interface 1005: an input part 1006 including a keyboard, a mouse, or the like; an output part 1007 including a cathode ray tube (CRT), a liquid crystal display (LCD), a speaker, or the like; the storage part 1008 including a hard disk, or the like; and a communication part 1009 including a network interface card such as a local area network (LAN) card and a modem. The communication part 1009 performs communication by using a network such as the Internet. A drive 1010 is also connected to the I/O interface 1005 as required. A removable medium 1011 such as a magnetic disk, an optical disk, a magneto-optical disk, or a semiconductor memory is installed on the drive 1010 as required, so that a computer program read from the removable medium is installed into the storage part 1008 as required.

According to some embodiments, the process described by referring to the flowchart in the above may be implemented as a computer software program. For example, some embodiments include a computer program product, including a computer program carried on a computer-readable medium, the computer program including program code for performing the method shown in the flowchart. In some embodiments, the computer program may be downloaded and installed from a network through the communication part 1009, and/or installed from the removable medium 1011. When the computer program is executed by the CPU 1001, various functions defined in the system, according to some embodiments, are performed.

The computer-readable medium described in some embodiments may be a computer-readable signal medium or a computer-readable storage medium or any combination of the above. The computer-readable storage medium may be, for example, but is not limited to, an electric, magnetic, optical, electromagnetic, infrared, or semi-conductive system, apparatus, or device, or any combination of the above. An example of the computer-readable storage medium may include but is not limited to: an electrical connection having one or more wires, a portable computer disk, a hard disk, a RAM, a ROM, an erasable programmable ROM (EPROM), a flash memory, an optical fiber, a portable compact disk ROM (CD-ROM), an optical storage device, a magnetic storage device, or any appropriate combination of the above. In some embodiments, the computer-readable storage medium may be any tangible medium that includes or stores a program. The program may be used by or used in combination with an instruction execution system, apparatus, or device. In some embodiments, a computer-readable signal medium may include a data signal being in a baseband or propagated as a part of a carrier wave, which carries a computer-readable computer program. A data signal propagated in such a way may have a plurality of forms, including but not limited to, an electromagnetic signal, an optical signal, or any appropriate combination of the above. The computer-readable signal medium may further be any computer-readable medium other than the computer-readable storage medium. The computer-readable medium may send, propagate, or transmit a program used by or in combination with the instruction execution system, apparatus, or device. The computer program included in the computer-readable medium may be transmitted by a medium, including but not limited to a wireless medium, a wired medium, or a combination thereof.

The flowcharts and block diagrams in the accompanying drawings illustrate exemplary system architectures, functions and operations that may be implemented by a system, a method, and a computer program product according to some embodiments. Each box in a flowchart or a block diagram may represent a module, a program segment, or a part of code. The module, the program segment, or the part of code includes one or more executable instructions used for implementing logic functions. In some embodiments, functions annotated in the blocks may also be executed in an order different from that annotated in the accompanying drawings. For example, two boxes shown in succession may actually be performed in parallel, and sometimes the two boxes may be performed in a reverse order. This depends on the functions involved. Each box of the block diagrams or the flowcharts and combinations of boxes in the block diagrams or the flowcharts may be implemented by a dedicated hardware-based system that performs functions or operations, or may be implemented by a combination of dedicated hardware and a computer program.

Some embodiments provide a computer-readable medium. The computer-readable medium may be included in the electronic device described in the above embodiments, or may exist alone without being installed into the electronic device. The foregoing computer-readable medium carries one or more computer programs. The one or more computer programs, when executed by the electronic device, cause the electronic device to implement the methods described in the above embodiments.

Through the foregoing descriptions, a person skilled in the art may readily understand that some embodiments described herein may be implemented by software, or may be implemented by combining software with hardware. Therefore, some embodiments may be implemented in a form of a software product. The software product may be stored in a non-volatile storage medium (which may be a CD-ROM, a USB flash drive, a removable hard disk, or the like) or on the network, including several instructions for enabling a computing device (which may be a personal computer, a server, a touch terminal, a network device, or the like) to perform the method according to some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data transmission optimization method, performed by a first application layer transmission optimization (ALTO) client, comprising:
obtaining, from a core network device, network transmission information of an access network exposed by an access network device to the core network device;
obtaining ALTO information provided by an ALTO server; and
performing data transmission optimization of the first ALTO client based on the ALTO information and the network transmission information of the access network.

2. The data transmission optimization method according to claim 1, wherein the ALTO information is transmitted from the ALTO server to the core network device via a second ALTO client, and
wherein the obtaining the ALTO information comprises obtaining the ALTO information from the core network device.

3. The data transmission optimization method according to claim 2, wherein the ALTO information is transmitted from the second ALTO client to a network exposure function (NEF) entity via a data network (DN), and
wherein the obtaining the ALTO information from the core network device comprises obtaining the ALTO information from the NEF entity.

4. The data transmission optimization method according to claim 2, wherein the ALTO information is transmitted to a network exposure function (NEF) entity by the second ALTO client via a data network (DN),
wherein the ALTO information is transmitted to an application function (AF) entity from the NEF entity, and
wherein the obtaining the ALTO information from the core network device comprises
obtaining the ALTO information from the AF entity.

5. The data transmission optimization method according to claim 1, wherein the obtaining the ALTO information comprises:
performing ALTO service discovery;
transmitting an ALTO information obtaining request to the ALTO server based on identifying the ALTO server; and
receiving the ALTO information from the ALTO server.

6. The data transmission optimization method according to claim 5, further comprising:
transmitting the ALTO information to the core network device via a data network (DN), to cause the core network device to expose the ALTO information to a second ALTO client.

7. The data transmission optimization method according to claim 6, wherein the transmitting the ALTO information to the core network device comprises transmitting the ALTO information to a user plane function (UPF) entity via the DN, to cause the UPF entity to provide the ALTO information to the second ALTO client via a network exposure function (NEF) entity.

8. The data transmission optimization method according to claim 1, wherein the obtaining the network transmission information comprises:
obtaining, from an application function (AF) entity, the network transmission information, the network transmission information of the access network being transmitted to the AF entity by the access network device via a protocol data unit (PDU) session between the access network device and the AF entity.

9. The data transmission optimization method according to claim 1, wherein the network transmission information comprises at least one of: wireless link state information, a throughput, transmission delay information, or delay jitter information, of the access network.

10. The data transmission optimization method according to claim 1, wherein the ALTO information comprises at least one of: IP-based dynamic network information, IP-based routing protocol unit information, or ALTO-based network configuration policy information.

11. A data transmission optimization apparatus, comprising:
at least one memory configured to store computer program code; and
at least one processor configured to read the program code and operate as instructed by the program code, the program code comprising:
first obtaining code configured to cause at least one of the at least one processor to obtain, from a core network device, network transmission information of an access network exposed by an access network device to the core network device;
second obtaining code configured to cause at least one of the at least one processor to obtain ALTO information provided by an ALTO server; and
processing code configured to cause at least one of the at least one processor to perform data transmission optimization of a first ALTO client based on the ALTO information and the network transmission information of the access network.

12. The data transmission optimization apparatus according to claim 11, wherein the ALTO information is transmitted from the ALTO server to the core network device via a second ALTO client, and
wherein the second obtaining code is configured to cause at least one of the at least one processor to obtain the ALTO information from the core network device.

13. The data transmission optimization apparatus according to claim 12, wherein the ALTO information is transmitted from the second ALTO client to a network exposure function (NEF) entity via a data network (DN), and
wherein the second obtaining code is configured to cause at least one of the at least one processor to obtain the ALTO information from the NEF entity.

14. The data transmission optimization apparatus according to claim 12, wherein the ALTO information is transmitted to a network exposure function (NEF) entity by the second ALTO client via a data network (DN),
wherein the ALTO information is transmitted to an application function (AF) entity from the NEF entity, and
wherein the second obtaining code is configured to cause at least one of the at least one processor to obtain the ALTO information from the AF entity.

15. The data transmission optimization apparatus according to claim 11, wherein the second obtaining code comprises:
discovery code configured to cause at least one of the at least one processor to perform ALTO service discovery;
first transmitting code configured to cause at least one of the at least one processor to transmit an ALTO information obtaining request to the ALTO server based on identifying the ALTO server; and
receiving code configured to cause at least one of the at least one processor to receive the ALTO information from the ALTO server.

16. The data transmission optimization apparatus according to claim 15, wherein the second obtaining code further comprises:
second transmitting code configured to cause at least one of the at least one processor to transmit the ALTO information to the core network device via a data network (DN), to cause the core network device to expose the ALTO information to a second ALTO client.

17. The data transmission optimization apparatus according to claim 16, wherein the second transmitting code is configured to cause at least one of the at least one processor to transmit the ALTO information to a user plane function (UPF) entity via the DN, to cause the UPF entity to provide the ALTO information to the second ALTO client via a network exposure function (NEF) entity.

18. The data transmission optimization apparatus according to claim 11, wherein the obtaining the network transmission information comprises:
obtaining, from an application function (AF) entity, the network transmission information, the network transmission information of the access network being transmitted to the AF entity by the access network device via a protocol data unit (PDU) session between the access network device and the AF entity.

19. The data transmission optimization apparatus according to claim 11, wherein the network transmission information comprises at least one of: wireless link state information, a throughput, transmission delay information, or delay jitter information, of the access network.

20. A non-transitory computer-readable medium, storing computer code which, when executed by at least one processor, causes the at least one processor to at least:
obtain, from a core network device, network transmission information of an access network exposed by an access network device to the core network device;
obtain ALTO information provided by an ALTO server; and
perform data transmission optimization of a first ALTO client based on the ALTO information and the network transmission information of the access network.
